(19) United States
(12) Patent Application Publication
(10) Pub. No.: US 2023/0283032 A1
(43) Pub. Date: Sep. 7, 2023

(54) COMPLIANT MECHANISM TOOL FOR CONNECTOR TERMINATION

(71) Applicant: CommScope Technologies LLC, Hickory, NC (US)

(72) Inventors: Timothy W. ANDERSON, Omaha, NE (US); Shawn Phillip TOBEY, Trinity, NC (US)

(21) Appl. No.: 18/317,221

(22) Filed: May 15, 2023

Related U.S. Application Data
(63) Continuation of application No. PCT/US2021/059216, filed on Nov. 12, 2021.
(60) Provisional application No. 63/237,998, filed on Aug. 27, 2021.
(60) Provisional application No. 63/113,286, filed on Nov. 13, 2020.

(51) Int. Cl. H01R 43/01; H01R 4/2433

(52) U.S. Cl. CPC H01R 43/015; H01R 4/2433

(57) ABSTRACT

A compliant mechanism tool for connector termination can be used to seat a rear body portion of a connector against or within a forward housing portion of the connector. Seating the rear body portion causes conductors, which are coupled to the rear body portion, to electrically couple with respective ones of contacts positioned with the forwarding housing. The compliant mechanism tool includes first and second handles that can be subjected to a squeezing motion causing connected first and second arms to propel a ram toward a head portion of the tool. The ram interfaces with the forward housing portion of the connector causing the forward housing to be pushed against the rear body portion causing seating of the rear body portion; motion of the forward housing is limited by a stop within the head portion of the tool.

### CROSS-REFERENCE TO RELATED APPLICATIONS

This application is a Continuation of International Patent Application No. PCT/US2021/059216, filed on Nov. 12, 2021, which claims the benefit of U.S. Pat. Application Serial No. 63/113,286, filed on Nov. 13, 2020, and claims the benefit of U.S. Pat. Application Serial No. 63/237,998, filed on Aug. 27, 2021, the disclosures of which are incorporated herein by reference in their entireties. To the extent appropriate, a claim of priority is made to each of the above disclosed applications.

### TECHNICAL FIELD

The present disclosure is directed to connector termination tools and, more specifically, to a compliant mechanism tool for connector termination.

### BACKGROUND

Terminating the conductors of an electrical cable to an electrical connector can be a tedious and time-consuming process if all steps of the termination must be performed manually, e.g. stripping the conductors of insulation and coupling the stripped wires to contacts of the connector. A tool capable of automating some or all the processes of termination can serve to improve speed and efficiency in configuring a location for power and data transmission. It is with these concerns in mind that the instant disclosure is presented.

### SUMMARY

A compliant mechanism tool for connector termination can be used to seat a rear body portion of a connector against a forward housing portion of the connector. Seating the rear body portion causes conductors, which are coupled to the rear body portion, to electrically couple with respective ones of contacts positioned with the forwarding housing. The compliant mechanism tool includes first and second handles that can be subjected to a squeezing motion causing connected first and second arms to propel a ram toward a head portion of the tool. The ram interfaces with the forward housing portion of the connector causing the forward housing to be pushed against the rear body portion causing seating of the rear body portion; motion of the forward housing is limited by a stop within the head portion of the tool.

An aspect of the present disclosure is directed to a cable termination tool. The cable termination tool includes a head portion, first and second handles, first and second arms and a ram. The head portion includes a centrally position channel which defines a central axis of the tool. The first and second handles are symmetric about the central axis and support the head portion. The first and second arms are symmetric about the central axis and extend, respectively, from the first and second arms towards the central axis. The ram is supported by the first and second arms and is aligned with the channel. Squeezing of the first and second handles towards the central axis causes the first and second arms to project the ram towards the channel of the head portion.

In certain embodiments, the head portion, the first and second handles, first and second arms and ram form a unitary body. In certain embodiments, each of the first and second handles includes a fin positions the respective first and second arms for the squeezing action. In certain embodiments, the ram includes an alignment feature that interfaces with a corresponding alignment feature on the head portion.

Another aspect of the present disclosure is directed to a cable termination tool of a unitary body construction comprising a head portion, first and second handles, first and second arms and a ram. The head portion includes a channel extending therethrough and has received a partially assembled connector within the channel. The partially assembled connector includes a forward housing and a rearward body portion. The forward housing includes a forward face, a rear face, and a pair of contacts. The rearward body portion is coupled to first and second conductors of a cable and is positioned proximate the rear face of the forward housing within the channel. Squeezing of the first and second handles causes the first and second arms to propel the ram toward and against the forward face of the forward housing until the rearward body portion is seated against the rear face of the forward housing. Seating of the rearward body portion causes the first and second conductors to be electrically coupled to a respective one of the contacts.

In certain embodiments, the forward housing comprises a forward body portion and a frame coupled to the forward body portion. In certain embodiments the forward housing includes only the pair of contacts. In certain embodiments, each contact of the pair of contacts includes a first end having an insulation displacement contact (IDC) and a second end having a tuning fork contact. In certain embodiments, the rear body portion is partially inserted into the forward housing prior to squeezing of the first and second handles.

Another aspect of the present disclosure is directed to a method of terminating a cable having first and second conductors with a tool that includes a head portion, first and second handles, first and second arms, and a ram. The method includes positioning a partially assembled connector in a channel of the head portion of the tool; the partially assembled connector includes a forward housing and a rearward body portion positioned proximate the forward housing in the channel. The forward housing includes first and second contacts, and the rearward body portion is coupled to the first and second conductors. The method further includes squeezing the first and second handles towards one another. The squeezing action causes the first and second arms to project the ram toward and against a forward face of the forward housing until the rearward body portion is seated against the forward housing. With the rearward body portion seated, the connector is fully assembled with the first and second conductors having been electrically coupled to a respective of the first and second contacts.

Another aspect of the present disclosure is directed to a method of terminating a cable having first and second conductors with a tool that includes a head portion, first and second handles, first and second arms, and a ram. The method includes positioning a partially assembled connector in a channel of the head portion of the tool; the partially assembled connector includes a first portion and a second portion. The method further includes squeezing the first and second handles towards one another. The squeezing action causes the first and second arms to project the ram toward and against the first portion until the second portion is seated within or against the first portion.

### BRIEF DESCRIPTION OF THE DRAWINGS

FIGS. 1A-1B illustrate example embodiments of cables having single twisted pairs of conductors.

FIGS. 2A-2E illustrate an example embodiment of a free connector for a single pair of electrical conductors including an assembled view, an exploded assembly view, a cross-section of a forward connector body of the connector, a pair of electrical contacts of the connector, and rear connector body of the connector, respectively.

FIG. 3 illustrates the connector of FIGS. 2A-2E with a single pair of conductors interfaced to a rear connector body of the connector.

FIG. 4 is a lower perspective view of the connector of FIGS. 2A-2E in a partially assembled configuration.

FIG. 5 is an upper perspective view of an embodiment of the compliant mechanism tool of the present disclosure and the partially assembled connector of FIG. 4.

FIG. 6 is a close-up upper perspective view of another embodiment of the compliant mechanism tool illustrating fins and alignment features of the tool.

FIGS. 7A-7B wherein FIG. 7A is a lower plan view of the compliant mechanism tool of FIG. 6 and FIG. 7B is lower plan view of another embodiment of the compliant mechanism tool.

FIG. 8 upper plan view of the compliant mechanism tool ready to be actuated with a connector in place.

FIG. 9 is an upper plan view of the compliant mechanism tool while being actuated.

FIG. 10 is an upper perspective view of the compliant mechanism tool and connector after actuation of the compliant mechanism tool.

FIG. 11 is an exploded view of a single pair Ethernet connector jack.

FIG. 12 is an upper perspective view of another embodiment of a compliant mechanism tool.

FIG. 13 is an upper perspective view of compliant mechanism tool of FIG. 12 and connector jack prior to actuation of the compliant mechanism tool.

FIG. 14 is an upper perspective view of the compliant mechanism tool and connector jack of FIG. 12 after actuation of the compliant mechanism tool.

### DETAILED DESCRIPTION

A compliant mechanism tool for connector termination generally comprises a head portion, first and second handles, first and second arms and a ram. The tool is designed about a central axis such that a channel of the head portion is aligned along the central axis as is the ram. First and second handles and first and second arms are symmetric to the sides of the central axis. The head portion receives a partially assembled connector that includes a rear body portion coupled to first and second conductors of a cable and a forward housing portion having a pair of contacts; full assembly requires that the rear body portion be seated against the forward body portion which causes an electrical interface to occur between the first and second conductors and respective ones of the pair of contacts. First and second handles support the head portion in a substantially fixed position while first and second arms, which extend inward toward the central axis from the first and second handles, support the ram. A squeezing action of the handles towards the central axis causes the first and second arms to propel the ram toward the head portion wherein the ram engages a forward face of the forward housing resulting in the forwarding housing being pushed towards the rear body portion until the rear body portion is seated against the forward housing. A stop within the channel limits motion of the forward housing as it is being pushed. In a preferred embodiment, the tool is of a unitary construction, however, a multi-component configuration is also possible. A unitary construction enables the tool to be quickly and inexpensively manufactured through a process such as injection molding.

Accordingly, the present disclosure illustrates and describes a connector termination tool that is of significantly lower cost than a traditional crimping and seating tool. Further, the present disclosure illustrates and describes a connector termination tool that is both small and lightweight compared to traditional crimping and seating tools enabling it to be easily carried by a technician in the field.

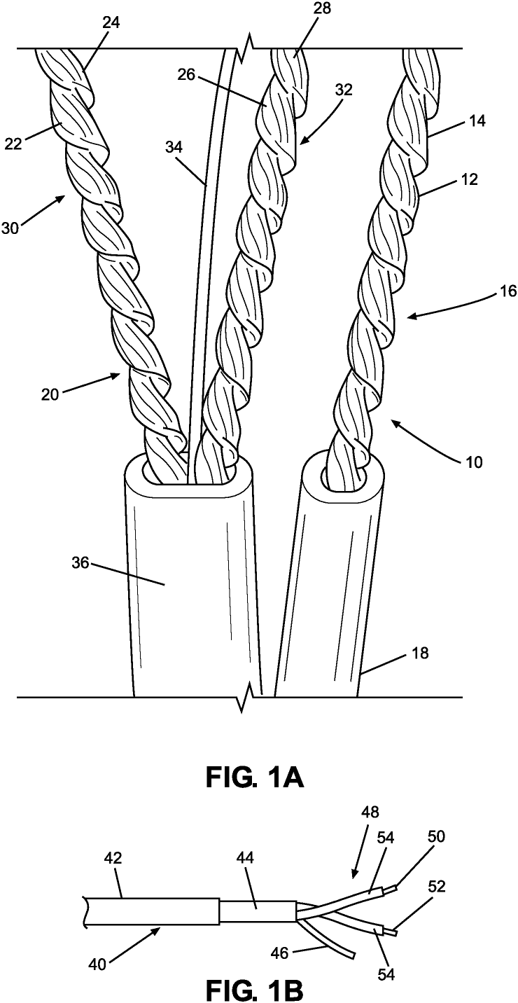

FIG. 1A illustrates two example embodiments of cables containing one or more single twisted pairs of conductors. The first cable 10 includes first and second conductors 12, 14 that are twisted together to form a single twisted pair 16. The conductors 12, 14 are enclosed by a protective jacket 18. The second cable 20 includes first through fourth conductors 22, 24, 26, 28. Conductors 22 and 24 are twisted together to form a first single twisted pair 30, and conductors 26 and 28 are twisted together to form a second single twisted pair 32. The twisted pairs 30 and 32 are separated by a separator 34 and are encased in a protective jacket 36. In certain example embodiments, the cables 10, 20 include a number of twisted pairs greater than two. In certain example embodiments, each single twisted pair of conductors, e.g., 16, 30, 32, is configured for simultaneously providing both data and power with data transmission up to 600 MHz (ffs) and a current carrying capacity up to 1 A. Each single twisted pair of conductors, e.g., 16, 30, 32, can be connectorized with the various embodiments or combination of embodiments of free connectors and fixed connectors as described herein. FIG. 1B is an example of a shielded cable 40. The shielded cable 40 includes an outer jacket 42, a foil shield 44, a drain wire 46, and a single twisted pair 48 of conductors 50 and 52; each of the conductors 50 and 52 is provided with insulation 54.

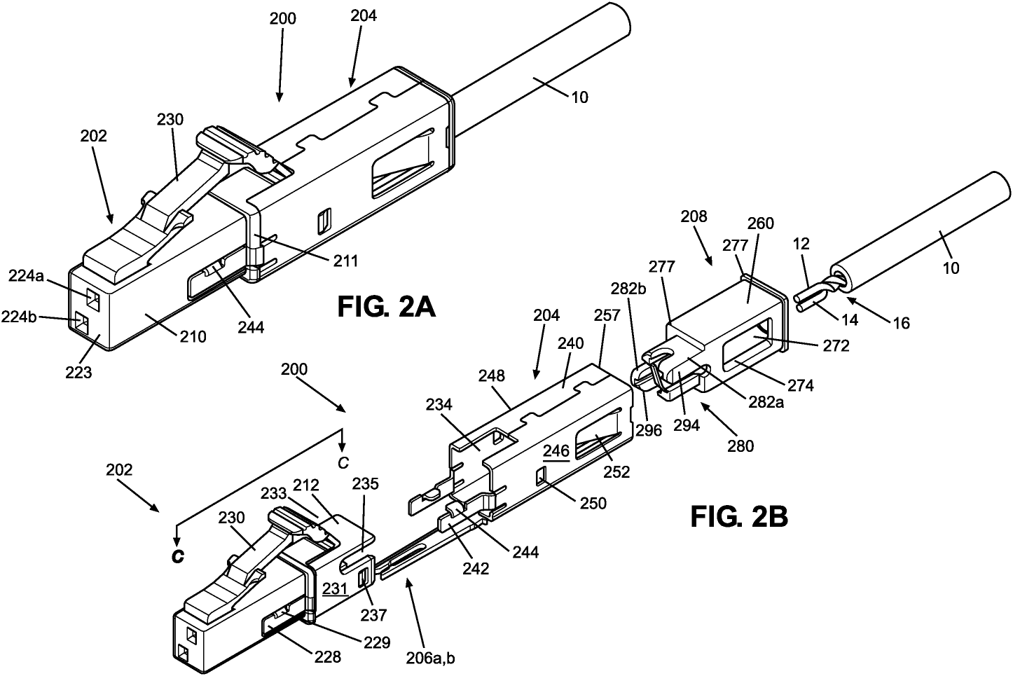

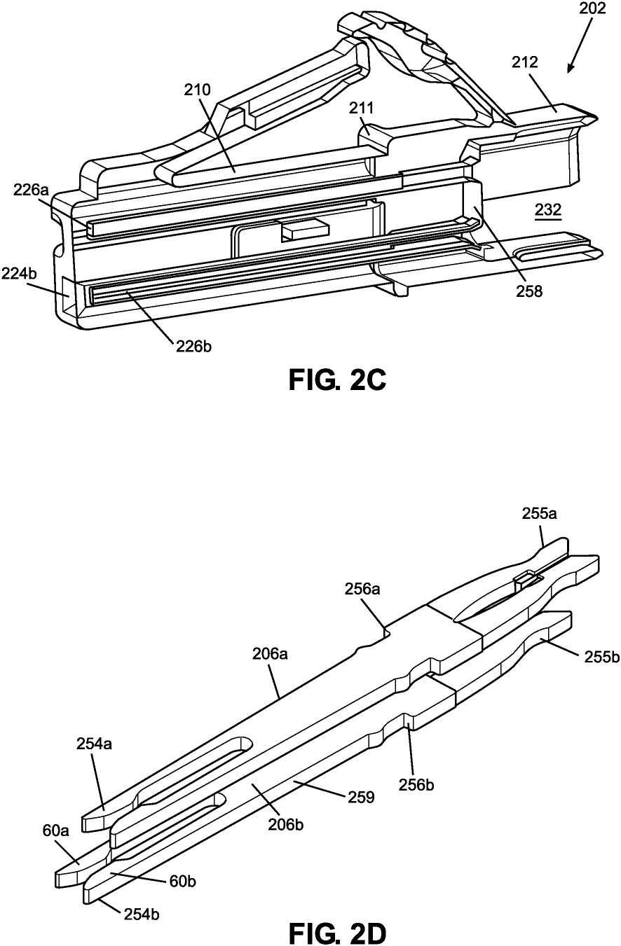

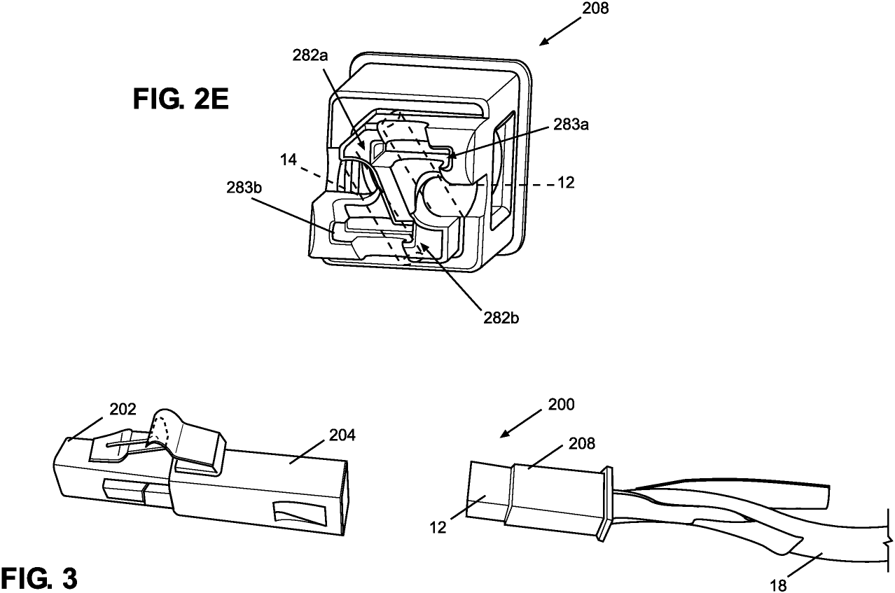

Referring to FIGS. 2A-2E an example embodiment of a free connector 200 for a single twisted pair of electrical conductors is illustrated. Free connector 200 includes a forward connector body 202, a metal frame 204, a pair of electrical contacts 206a, 206b and a rear connector body 208. Free connector 200 can be coupled to a single twisted pair of conductors, e.g., conductors 12 and 14 of the single twisted pair 16 of cable 10.

The forward connector body 202 includes an elongate forward portion 210 and a rear receiving portion 212 that is separated by a shoulder 211.

The elongate forward portion 210 of the forward connector body 202 includes a forward face 223 having a pair of offset openings, 224b corresponding to contact receiving channels 226a, 226b; the openings 224a, 224b receive pin contacts that electrically interface with the tuning fork contacts 206a, 206b. In certain embodiments, a recess 228 is provided on each side face of the elongate forward portion 210 to interface with and retain the metal frame 204. Each recess 228 includes a recessed notch 229 to receive an interfacing tab 244 of the metal frame 204 to further ensure that the metal frame 204 remains secured to the forward connector body 202. The forward connector body 202 also includes a cantilevered latch 230.

The rear receiving portion 212 of the forward connector body 202 is unitary (e.g. molded as a single unit) with the elongate forward portion 210 of the forward connector body 202. The rear receiving portion 212 defines a central cavity 232 that provides rear access to the contact receiving channels 226a, 226b of the elongate forward portion 210. Each side face 231, 233 of the rear receiving portion 212 includes a slot 235 to interface with the rear connector body 208 and an outward extending tab 237 to interface with the metal frame 204.

The metal frame 204 of the free connector 200 comprises a metal shell body 240 having a central cavity 234 that is slidable over the rear receiving portion 212 of the forward connector body 202. The metal frame 204 is held in place about the rear receiving portion 212 through use of a pair of flex tabs 242 that interface with corresponding recesses 228 of the forward connector body 202. Each of the flex tabs 242 includes in inward facing tab 244 to interface with recessed notch 229 of the forward connector body 202. Each side face 246, 248 of the metal frame 204 includes an opening 250 to interface with outward extending tab 237 of the forward connector body 202. Each point of interface between the metal frame 204 and the forward connector body 202 assists in securing the metal frame 204 to the forward connector body 202. Each side face 246, 248 of the metal frame 204 is additionally equipped with an inward directed beam 252 (e.g. shield beam) to establish an electrical interface with a cable shield (foil or drain wire) of the cable carrying the single pair of conductors (e.g., see FIG. 1B). Note that, while the metal frame 204 includes a shield beam for interfacing with a shield of a shielded cable, the metal frame 204 can also be utilized in conjunction with a non-shielded cable. In the instance of a non-shielded cable, the metal frame provides additional structural support to the connector 200. In certain non-shielded uses, the frame 204 is alternatively made of a non-metal material, e.g., plastic. The frame 204, metal or non-metal, in combination with the forward connector body 202 form a forward housing of the free connector 200.

Electrical contacts 206a, 206b each include a forward portion having a tuning fork receptacle contact 254a, 254b while a rear portion of each of the electrical contacts 206a, 206b includes an insulation displacement contact (IDC) 255a, 255b. Each tuning fork receptacle contact 254a, 254b includes a pair of opposing spring arms 60a, 60b presenting an angled opening to receive a pin contact. Each of the electrical contacts 206a, 206b includes a shoulder 256a, 256b that interfaces with a stop 258 (see FIG. 2C) within the elongate forward portion 210 of the forward connector body 202. The electrical contacts 206a, 206b include one or more tangs 259 to help retain each of the tuning fork receptacle contacts 254a, 254b within their respective contact receiving channels 226a, 226b of the forward connector body 202.

The rear connector body 208 of the free connector 200 includes a rear body portion 260 that defines a central cavity 272 into which is inserted a pair of conductors (e.g., conductors 12, 14). Each side face is provided with an elongate opening 274 into which the inward directed beams 252 of the metal frame 204 extend wherein an electrical interface with the foil (or drain wire) of a conductor within the cavity 272 is established. A latch (not shown) on a lower face of the rear body portion 260 interfaces with a cut-out (not shown) of the metal frame 204 to secure the rear connector body 208 to the metal frame 204. A lip edge 277 of the rear body portion 260 seats against a rear face 257 of the metal frame 204.

The rear connector body 208 of the free connector 200 includes a contact receiving portion 280 that extends forward from the rear body portion 260. The contact receiving portion 280 is essentially divided into a first half 282a to accommodate the upper positioned electrical contact 206a and a second half 282b to accommodate the lower positioned electrical contact 206b. The first half 282a of the contact receiving portion 280 includes an upward channel that is contoured to direct the end of a conductor upward (e.g., a ~90 deg. bend) to extend through a contact receiving slot 283a. The second half 282b of the contact receiving portion 280 includes a downward channel that is contoured to direct the end of a conductor downward (e.g., a ~90 deg. bend) to extend through a contact receiving slot 283b (see FIG. 2E).

The IDC contacts 255a, 255a of the electrical contact 206a,206b are inserted into their respective contact receiving slots to establish an electrical interface with the conductor extending there through. The IDC contacts 255a, 255b applies a normal force to the respective conductor and cuts through both the insulation of the conductor and a portion of the conductor itself to create the electrical interface. Note that the electrical interface is established without requiring crimping of the conductor to the electrical contact, i.e. the electrical interface is crimp-less. The upward channel is, in part, defined by an upper outward extending arm 294 while the downward channel is, in part, defined by a lower outward extending arm 296. Each of upper outward extending arm 294 and lower outward extending arm 296 interface with respective corresponding slots 235 of the forward connector body 202 when the free connector 200 is assembled to assist in aligning and stabilizing the rear connector body 208 relative to the forward connector body 202.

Further details regarding the free connector 200 and/or a fixed connector 300 (described herein for reference) can be found in PCT Publication WO 2019/165466, entitled “Connectors and Contacts for a Single Twisted Pair of Conductors,” and filed Feb. 26, 2019. The noted PCT Publication is hereby incorporated by reference in its entirety.

In assembling the free connector 200, the electrical contacts 206a, 206b are inserted within their contact receiving channels 226a, 226b of the forward connector body 202 and the metal frame 204 is secured to the forward connector body 202. Further, the single pair of conductors, e.g. conductors 12, 14, are inserted through the central cavity 272 of the rear connector body 208 and positioned within respective contact receiving slots 283a, 283b. FIG. 3 illustrates the connector 200 with these assembly steps completed leaving the rear connector body 208 to be inserted into the metal frame 204 for final assembly of the connector 200.

The final steps in assembling the connector 200 include inserting the rear connector body 208 into the metal frame 204 and seating the rear connector body 208 against the metal frame 204 whereby the conductors, e.g., conductors 12, 14, electrically interface with respective IDCs 255a, 255b, of the contacts 206a, 206b (see FIG. 2D).

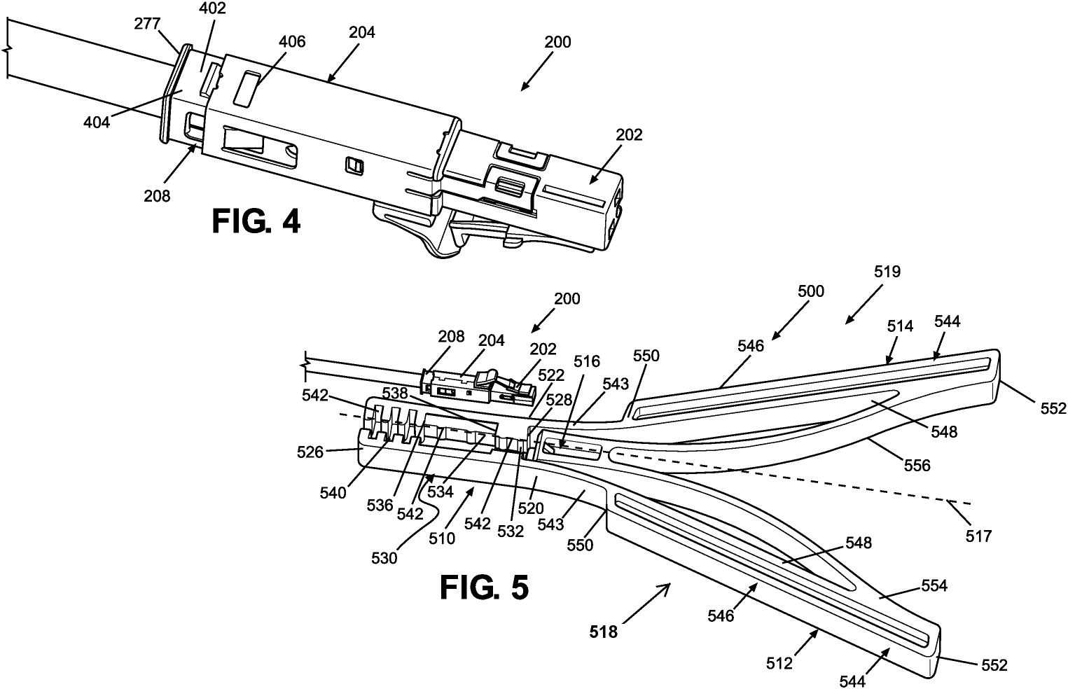

FIG. 4 illustrates the rear connector body 208 of the connector 200 in a partially inserted position relative to the metal frame 204 ready to be seated against the metal frame. FIG. 4 is bottom perspective view of the connector 200 illustrating that the rear connector body 208 includes a latch 402 on a lower face 404 that mechanically interfaces with a cut-out 406 of the metal frame 204 to secure the rear connector body 208 to the metal frame 204. The lip edge 277 of the rear connector body 208 that seats against the rear face 257 of the metal frame 204 is also illustrated.

FIG. 5 illustrates an embodiment of a compliant mechanism tool 500 for connector termination according to the present disclosure. More specifically, the compliant mechanism tool is used to seat the rear connector body 208 to the metal frame 204 of the connector 200 causing contacts 206a, 206b (see FIGS. 2B and 2D) positioned within the forward connector body 202 to be received within contact receiving slots 283a, 283b of the rear connector body 208 and interface with conductors 12, 14 (e.g., cutting through the insulation surrounding each of the conductors to make electrical contact with the copper wires therein).

As shown in FIG. 5, the compliant mechanism tool 500 is preferably of a unitary construction that is fabricated through injection molding of one or more flexible materials such as nylon, acetal, or polypropylene; however, a compliant mechanism tool 500 composed of a plurality of distinct and interfacing components is also possible. The compliant mechanism tool 500 includes a head portion 510 that receives and positions the connector 200 with the rear connector body 208 of the connector 200 in an unseated configuration. The compliant mechanism tool 500 additionally includes a first handle 512, a second handle 514 and a ram 516 connected to the first and second handles 512, 514. A central axis 517 can be deemed as dividing the compliant mechanism into a first half 518 and a second half 519. In certain embodiments the first half 518 is symmetrical to the second half 519.

Further details of the compliant mechanism tool 500 can be appreciated with respect to FIG. 5-7A. The head portion 510 includes first and second side walls 520, 522 connected by a lower face 524 as well as a forward face 526 and a rearward face 528. A connector channel 530 extends between the forward and rearward faces 526, 528. The connector channel 530 includes a rearward portion 532 that is sized to accommodate a width of the forward connector body 202 of the connector 200. The connector channel 530 additionally includes a central portion 534, which is sized to accommodate a width of the metal frame 204 and rear body portion 208 of the connector 200. The central portion 534 of the connector channel 530 is additionally defined by first and second stops 536, 538 (e.g., walls that extend into the channel 530) to contain a length of the metal frame 204 and the rear connector body 208 prior to being seated. The connector channel 530 additionally includes a forward portion 540 that is sized to accommodate a width of a cable, e.g., cable 16 (see FIG. 1A), containing the single pair of conductors. In certain embodiments, each of the rear, central and forward portions 532, 534, 540 of the connector channel 530 includes one or more retention features 542, e.g. projections into the respective portions of the connector channel 530, that help to retain the connector 200 within the connector channel 530. The center of the connector channel 530 is aligned along the central axis 517 of the compliant mechanism tool 500.

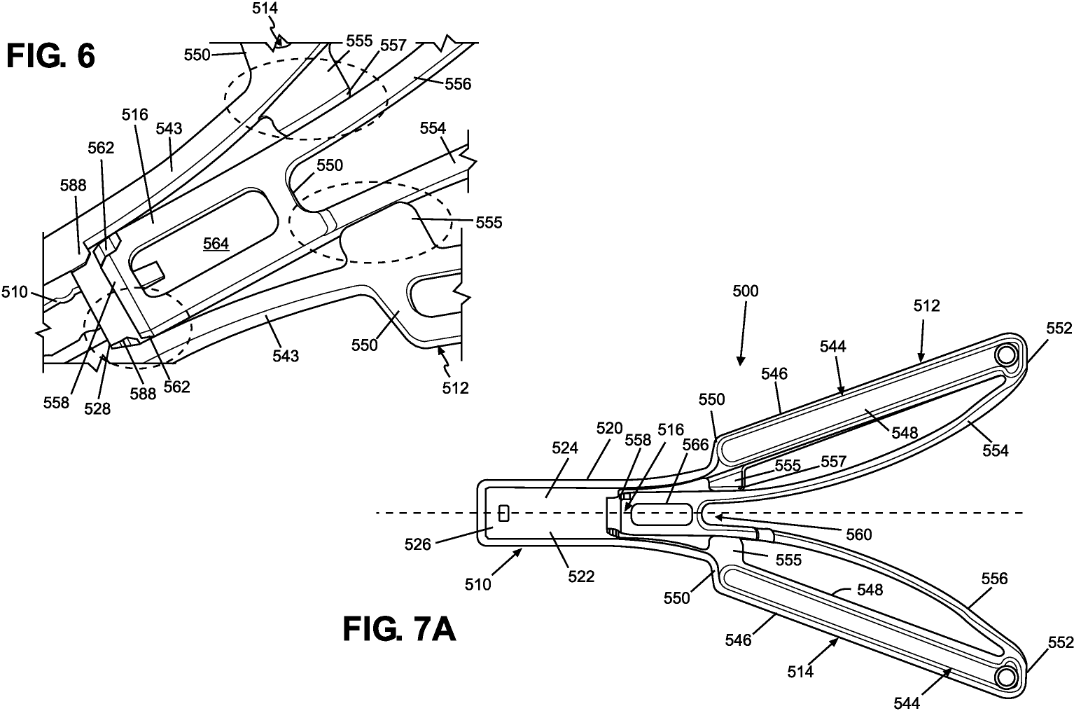

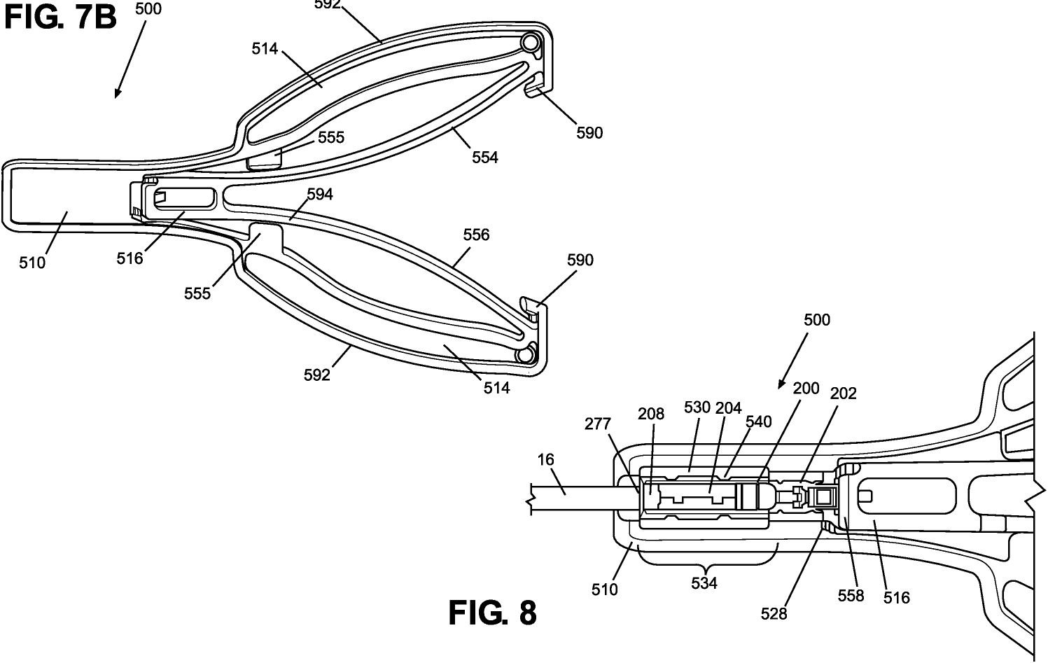

Each of the first and second handles 512, 514 of the compliant mechanism tool 500 extends from a neck portion 543 that lies intermediate the head portion 510 and the respective handle 512, 514. Each of the handles 512, 514, which are equidistantly spaced from the center axis 517, includes a substantially rectangular outer portion 544 having a substantially straight elongate outer wall 546 and a substantially straight elongate inner wall 548, each of which extends between a forward face 550 and a rearward face 552. First and second arms 554, 556 extend away from the inner wall 548 of each of the respective first and second handles 512, 514 toward the central axis 517. The first and second arms 554, 556 support either side of the ram 516. In certain embodiments, see FIG. 6-7B, each of the first and second handles 512, 514 includes a fin 555 having a beveled edge 557 proximate the respective first and second arms 554, 556. The beveled edge 557 of the fin 555 assists in ensuring the fin 555 is positioned against the respective arm 554, 556 to position the respective arm 554, 556 in a desired position for actuation of the compliant mechanism tool 500. Each of the fins 555 is designed to engage the respective arm 554, 556 if the arm 554, 556 is out of alignment and then helps to prevent further misalignment of the arm 554, 556.

The ram 516 is an element in a square or rectangular configuration that presents a flat forward face 558. The forward face 558 and a rearward face 560 spanning the distance between the first and second arms 554, 556. In certain embodiments, the ram 516 includes an alignment feature to assist the ram 516 in maintaining a desired position during actuation of the compliant mechanism tool 500. FIG. 6 illustrates such an alignment feature, which includes a recessed corner 562 on an upper face 564 and a lower face 566 ram that interfaces with a corresponding projection 588 extending from the rearward face 528 of the head portion 510.

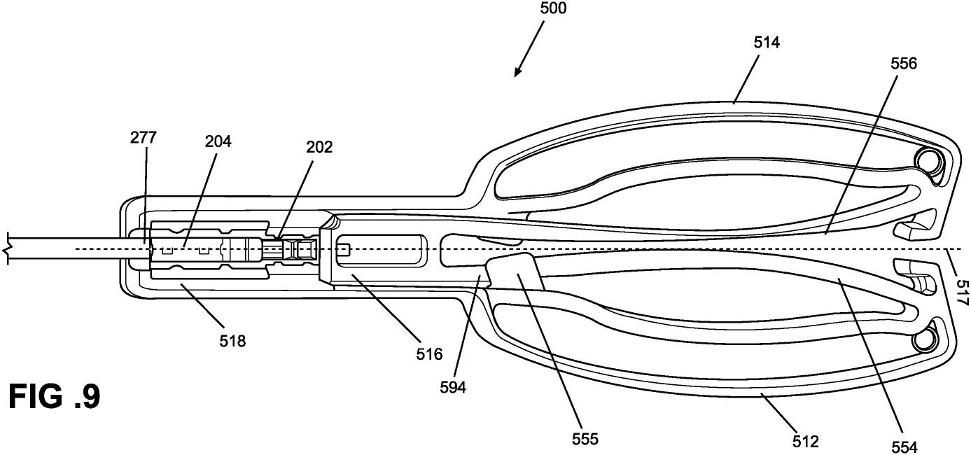

FIG. 7B illustrates another embodiment of the compliant mechanism tool 500 that illustrates each of the first and second handles 512, 514 including opposing stop features 590 at a rearward end. Upon actuation of the tool 500, the opposing stop features 590 may meet to prevent over travel of the handles 512, 514 and, thus, limit the travel of the ram 516. Further, the first and second handles 512, 514 are provided with a more ergonomic design including a convex outer grip surface 592, which provides a more advantageous finishing position of the first and second handles 512, 514 when actuated. A recess 594 is additionally provided in each of first and second arms 554, 556 with one recess 594 top-side of the first arm 554 (see FIG. 9) and the other recess 594 bottom-side of the second arm 556 enabling fins 555 to pass over the respective recess 594 during tool actuation.

FIGS. 8-10 illustrate the compliant mechanism tool 500 and the connector 200 in configurations prior to, during and after actuation, respectively, of the compliant mechanism tool 500. As shown in FIG. 8, prior to actuation, the partially assembled connector 200 is placed within the connector channel 530 of the head portion 510 of the tool 500 with the unseated rear body portion 208 and the metal frame 204 contained in the central portion 534 of the connector channel 530, the single pair cable, e.g., cable 16, extending from the forward portion 540 of the connector channel 530 and the forward body portion 202 of the connector 200 positioned within the rearward portion 532 of the connector channel 530. The forward body portion 202 of the connector 200 extends beyond the rearward face 528 of the head portion 510 by a distance that is approximately equivalent to the distance between the lip edge 277 of the rearward body portion 208 of the connector 200 and the metal frame 204 of the connector 200.

During actuation, as shown in FIG. 9, the first and second handles 512, 514 are gripped within a user’s hand and squeezed toward the center axis 517. The squeezing motion causes the first and second arms 554, 556 of the compliant mechanism tool 500 to move the ram 516 forward thereby pressing against the forward connector body 202 of the connector 200. The pressure against the forward connector body 202 pushes the forward connector body 202 and the metal frame 204 against the rear body portion 208 of the connector 200 until the lip edge 277 of the rear body portion 208 is seated against the metal frame 204 of the connector 200. The seating of the rear body portion 208 of the connector 200 causing the IDCs 255a, 255b, of the contacts 206a, 206b within the forward body portion 202 of the connector 200 to electrically to interface with the cable conductors, e.g., conductors 12, 14, that are positioned within the rear body portion 208 of the connector 200.

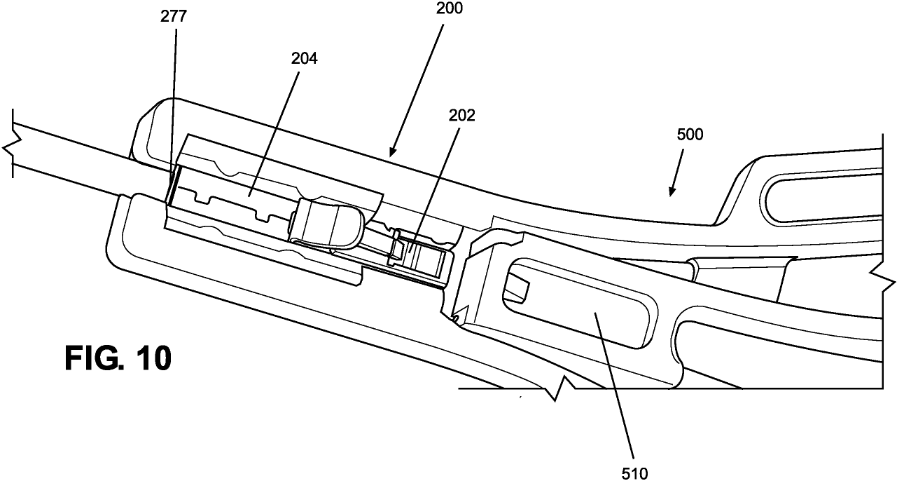

Referring to FIG. 10, once the rear body portion 208 of the connector 200 is seated against the metal frame 204, the squeezing pressure on the first and second handles 512, 514 of the compliant mechanism tool 500 can be released allowing the ram 516 to move rearward away from the head portion 510. Termination and assembly of the connector 200 is now complete and the connector can be removed from the head portion 510. The compliant mechanism tool 500 can be repeatedly used to terminate cables and fully assemble further connectors 200.

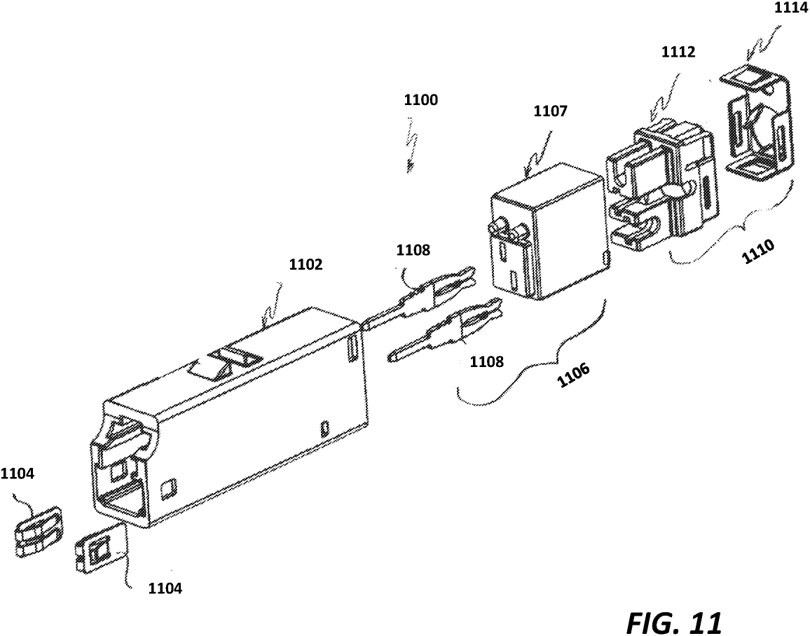

Referring now to FIG. 11, a connector jack 1100 for interfacing at a first end with the connector 200 and for interfacing at a second end with first and second conductors, e.g., conductors 12, 14, to transmit both power and data between the connector 200 and conductors 12, 14 is illustrated. As shown, the connector jack 1100 generally includes a singular metal housing 1102, two bonding shield contacts 1104, a forward sub-assembly 1106 that includes a forward housing 1107 supporting contacts 1108 and a rear sub-assembly 1110 that includes a rearward housing 1112 and a metal bonding shield panel 1114. The forward sub-assembly 1106 is configured to interface with the connector 200 while the rear sub-assembly 1110 is configured to interface with the conductors 12, 14. Additional details regarding the connector jack 1100 can be found in U.S. Provisional Pat. Application No. 63/237,998, filed Aug. 27, 2021 and entitled “SINGLE PAIR ETHERNET CONNECTOR JACK,” which is hereby incorporated by reference. It should be noted that in non-shielded applications, the housing 1102 and the panel 1114 may be fabricated from plastics, polymers or other appropriate non-metallic materials.

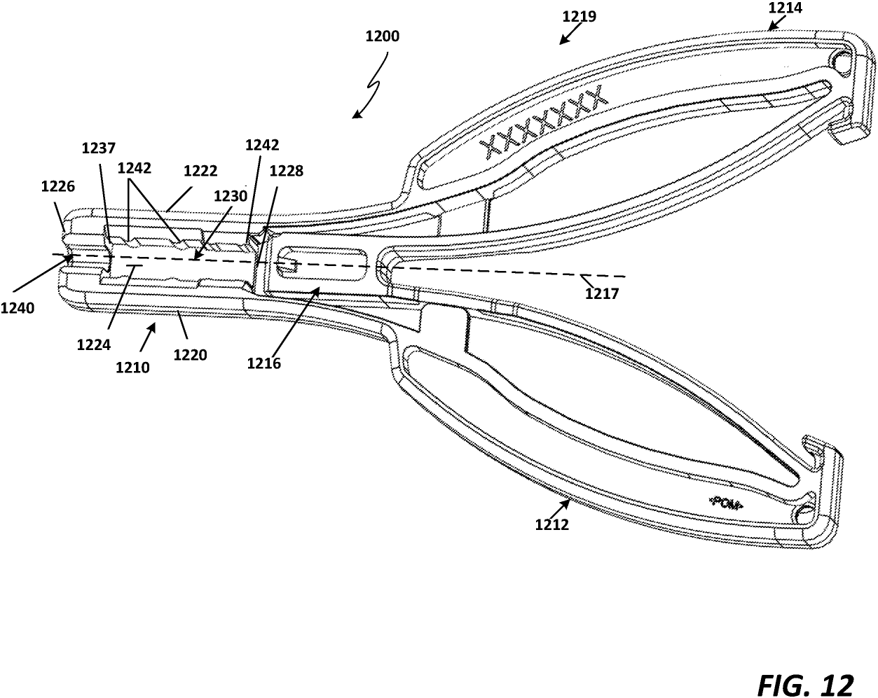

During assembly of the connector jack 1100, the bonding shield panel 1114 is secured to the rearward housing 1112. Conductors 12, 14 are fed through the bonding shield panel 1114 and laced within the rearward housing 1112. The rearward housing 1112, and attached bonding shield panel 1114, are then inserted into the forward housing 1107. An insulation displacement contact (IDC) end of each of the dual-ended contacts 1108 is then inserted into respective slots within the forward housing 1107 to establish an electrical interface with the conductors 12, 14. The combined assembled forward and rear sub-assemblies 1106, 1110 are then positioned within a rear opening of the housing 1102 and can be fully seated therein through use of a compliant mechanism tool 1200, illustrated in FIGS. 12-14.

FIGS. 12-14 illustrate the compliant mechanism 1200 without the jack connector 1100, with the jack connector 1100 prior to seating the combined assembled forward and rear sub-assemblies 1106, 1110, and subsequent seating the combined assembled forward and rear sub-assemblies 1106, 1110, respectively, through actuation of the compliant mechanism 1200 (note that conductors 12, 14 of cable 10 extending from the jack connector 1100 are not shown). The compliant mechanism 1200 generally corresponds to compliant mechanism 500 having similar operability and a unitary construction that is fabricated through injection molding of one or more flexible materials such as nylon, acetal, or polypropylene (a compliant mechanism tool 1200 composed of a plurality of distinct and interfacing components is also possible). The compliant mechanism tool 1200 includes a head portion 1210 that receives and positions the jack connector 1100 with the combined forward and rear sub-assemblies 1106, 1110 in an unseated configuration. The compliant mechanism tool 1200 additionally includes a first handle 1212, a second handle 1214 and a ram 1216 connected to the first and second handles 1212, 1214. A central axis 1217 can be deemed as dividing the compliant mechanism into a first half 1218 and a second half 1219. In certain embodiments the first half 1218 is symmetrical to the second half 1219.

The head portion 1210 of the compliant mechanism 1200 includes first and second side walls 1220, 1222 connected by a lower face 1224 as well as a forward face 1226 and a rearward face 1228. A connector jack channel 1230 extends between the forward and rearward faces 1226, 1228. The connector jack channel 1230 is sized to accommodate a width of the housing 1102 of the connector jack 1100. The connector jack channel 1230 includes a forward stop 1237 (e.g., a wall that extends into the channel 1230) to contain a length of both the housing 1102 and the combined assembled forward and rear sub-assemblies 1106, 1110 of the connector jack 1100 prior to sub-assemblies being seated. The connector jack channel 1230 additionally includes a forward portion 1240 that is sized to accommodate a width of a cable, e.g., cable 16 (see FIG. 1A), containing the single pair of conductors. In certain embodiments, the connector jack channel 1230 and/or the forward portion 1240 of the connector jack channel 1230 includes one or more retention features 1242, e.g., projections, that help to retain the connector jack 1100 within the connector jack channel 1230. The center of the connector jack channel 1230 is aligned along the central axis 1217 of the compliant mechanism tool 1200.

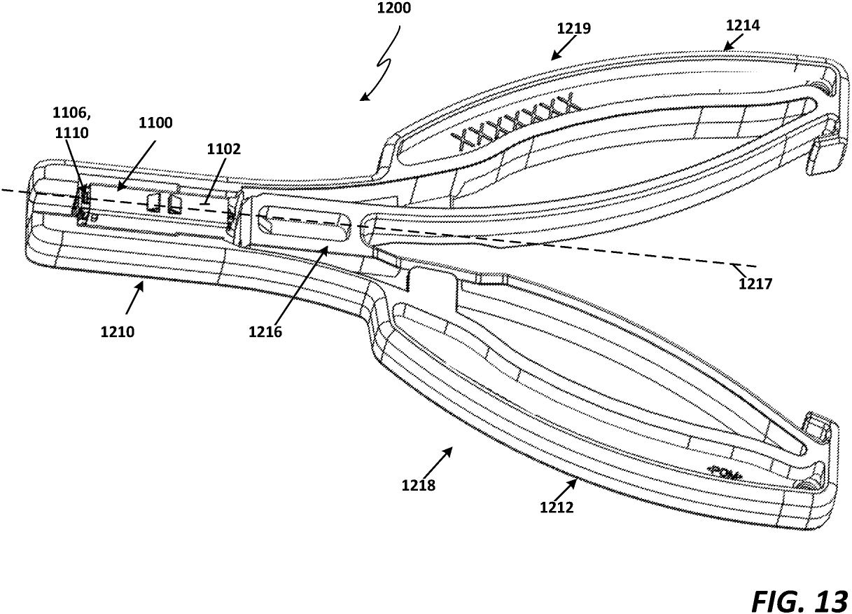

Prior to actuation of the compliant mechanism tool 1200, as illustrated in FIG. 13, the unseated combined sub-assemblies 1106, 1110 and the housing 1104 of the connector jack 1100 are placed within the connector jack channel 1230 of the head portion 1210 of the tool 1200 with the single pair cable, e.g., cable 16, lying within forward portion 1240 of the connector jack channel 1230.

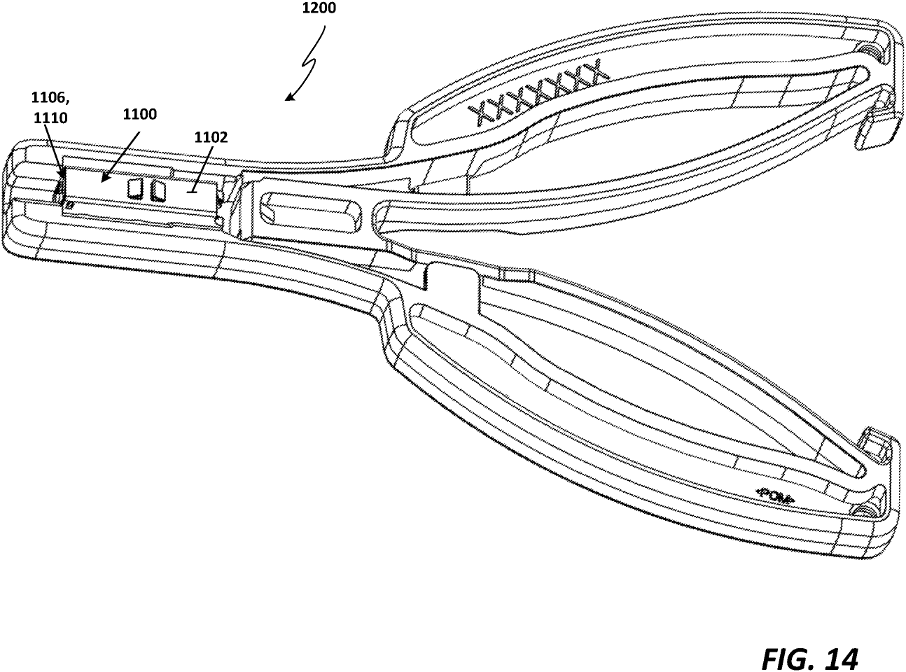

Actuation of the compliant mechanism tool 1200 corresponds to the actuation of the compliant mechanism tool 500. The first and second handles 1212, 1214 are gripped within a user’s hand and squeezed toward the center axis 1217. The squeezing motion causes the ram 1216 to move forward thereby pressing against the housing 1102 of the connector jack 1100. The pressure against the housing 1102 pushes the housing 1202 towards the forward stop 1237 causing the combined sub-assemblies 1106, 1110 to be seated within the housing 1102 of the connector jack 1100, as illustrated in FIG. 14.

Once the combined sub-assemblies 1106, 1110 of the connector jack 1100 are seated within the housing 1102, the squeezing pressure on the first and second handles 1212, 1214 of the compliant mechanism tool 1200 can be released allowing the ram 1216 to move rearward away from the head portion 1210. Termination of the connector jack 1100 is now complete and the connector jack 1100 can be removed from the head portion 1210. The compliant mechanism tool 1200 can be repeatedly used to terminate cables, e.g., cable 16, to connector jack 1100.

It should be appreciated that aspects of the various embodiments described herein may be combined in any number of ways to provide numerous additional embodiments. These embodiments are not described individually for the sake of brevity.

While the present invention has been described above primarily with reference to the accompanying drawings, it will be appreciated that the invention is not limited to the illustrated embodiments; rather, these embodiments are intended to disclose the invention to those skilled in this art. In the drawings, like numbers refer to like elements throughout. Thicknesses and dimensions of some components may be exaggerated for clarity.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

Spatially relative terms, such as “under”, “below”, “lower”, “over”, “upper”, “top”, “bottom”, “forward”, “rearward”, and the like, may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, operations, elements, and/or components, but do not preclude the presence or addition of one or more other features, operations, elements, components, and/or groups thereof.

Herein, the terms “attached”, “connected”, “interconnected”, “contacting”, “mounted” and the like can mean either direct or indirect attachment or contact between elements, unless stated otherwise.

Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

What is claimed:

1. A cable termination tool, comprising:
a head portion having a channel and a central axis extending along the channel;
first and second handles symmetric about the central axis and supporting the head portion;
first and second arms symmetric about the central axis, the first and second arms extending from respective first and second handles towards the central axis;
a ram supported by the first and second arms, the ram aligned with the channel,
wherein squeezing the first and second handles towards the central axis causes the first and second arms to project the ram towards the channel of the head portion.

2. The cable termination tool of claim 1, wherein the head portion, the first and second handles, the first and second arms, and the ram form a unitary body.

3. The cable termination tool of claim 1, wherein each of the first and second handles includes a fin that positions the respective first and second arms for the squeezing action.

4. The cable termination tool of claim 1, wherein the ram includes an alignment feature that interfaces with a corresponding alignment feature on the head portion.

5. The cable termination tool of claim 1, wherein the channel includes a central portion defined by front and rear stops.

6. The cable termination tool of claim 5, wherein the channel includes a forward and rear portion having a narrower width than the central portion.

7. The cable termination tool of claim 1, wherein the channel includes a plurality of retention projections to retain a cable and/or a connector inserted therein.

8. A cable termination tool, comprising:
a unitary body comprising a head portion, first and second handles, first and second arms, and a ram;
wherein the head portion includes a channel extending therethrough, the channel having received a partially assembled connector that includes a forward housing and a rearward body portion, the forward housing including a forward face, a rear face, and a pair of contacts, the rearward body portion being coupled to first and second conductors of a cable and the rearward body portion being positioned proximate the rear face of the forward housing,;
wherein squeezing of the first and second handles causes the first and second arms to propel the ram toward and against the forward face of the forward housing until the rearward body portion is seated against the rear face of the forward housing and each of the first and second conductors of the cable are electrically coupled to a respective one of the pair of contacts.

9. The cable termination tool of claim 8, wherein the channel and ram are aligned along a central axis of the unitary body.

10. The cable termination tool of claim 9, wherein the first and second handles and the first and second arms are symmetric about the central axis.

11. The cable termination tool of claim 8, wherein each of the first and second handles includes a fin that that positions respective first and second arms for the squeezing action.

12. The cable termination tool of claim 8, wherein the ram includes an alignment feature that interfaces with a corresponding alignment feature on the head portion.

13. The cable termination tool of claim 8, wherein the forward housing includes a forward body portion and a frame coupled to the forward body portion.

14. The cable termination tool of claim 8, wherein the forward face of the forward housing portion extends beyond the head portion toward the ram.

15. The cable termination tool of claim 8, wherein the forward housing includes only the pair of contacts.

16. The cable termination tool of claim 8, wherein each contact of the pair of contacts comprises includes a first end having an insulation displacement contact (IDC) and a second end having a tuning fork contact.

17. The cable termination tool of claim 8, wherein the rear body portion is partially inserted in the forward housing prior to squeezing of the first and second handles.

18. The cable termination tool of claim 8, wherein the channel includes a central portion defined by forward and rear stops, at least one of the forward and rear stops limiting motion of the forward housing in the channel while the ram is propelled.

19. The cable termination tool of claim 8, wherein a portion of the channel supports a portion of the cable.

20. A method of terminating a cable having a first and second conductors with a tool that includes a unitary body comprising a head portion, first and second handles, first and second arms, and a ram, the method comprising:
positioning a partially assembled connector having a first portion and a second portion in a channel of the head portion of the tool,
squeezing the first and second handles towards one another, the squeezing action causing the first and second arms to project the ram toward and against the first portion until the second portion is seated within or against the first portion.
